(19) United States
(12) Patent Application Publication
(10) Pub. No.: US 2013/0003495 A1
(43) Pub. Date: Jan. 3, 2013

(54) PROPELLER ASSEMBLY COMPRISING ONE HUB AND AT LEAST TWO BLADES

(75) Inventor: Thomas Pyddoke, Arsta (SE)

(73) Assignee: XYLEM IP HOLDINGS LLC, White Plains, NY (US)

(21) Appl. No.: 13/635,123

(22) PCT Filed: Mar. 14, 2011
(86) PCT No.: PCT/SE2011/050274

§ 371 Date: Sep. 14, 2012

(30) Foreign Application Priority Data
Mar. 17, 2010 (SE) 1050242-5

(51) Int. Cl. B01F 7/00

(52) U.S. Cl. 366/343

(57) ABSTRACT

The inventions refer to a mixer assembly for generating and maintaining a movement within waste water, comprising a hub (3) and at least two blades (4), which are disengageably connected to said hub (3), the hub (3) in a rear end being arranged to be connected to a drive shaft and thereby being arranged to be driven in rotation about an axially extending centre axis. According to the invention the hub (3) comprises a seat (9) for each of said at least two blades (4), each seat (9) comprising an axially extending first engagement means (10), and that each blade (4) comprises an axially extending second engagement means (11), said first engagement means (10) and said second engagement means (11) together being arranged to admit axial mutual displacement of said hub (3) and each of said blades (4) during mounting/demounting of the propeller assembly, and is thereto arranged to prevent radial mutual displacement of said hub (3) and each of said blades (4) when the mixer assembly is in an assembled condition.

### TECHNICAL FIELD OF THE INVENTION

The present invention relates in general to a propeller assembly for generating and maintaining a movement within waste water comprising more or less unfiltered, contaminated liquid comprising solid matter such as plastics, hygiene articles, fabrics, rags, grit, etc. The term waste water comprises for instance surface water and sewage, however, it should be pointed out that the present invention is also suitable for being used with fresh water and other liquids. The term propeller assembly means at first hand mixer assemblies of mixers and impeller assemblies of propeller pumps. The present invention relates in particular to a propeller assembly for generating and maintaining a movement within waste water, comprising a hub and at least two blades, which are disengageably connected to said hub and which extends in the radial direction in relation to the hub, furthermore the hub presents a free front end and a rear end, the hub in said rear end being arranged to be connected to a drive shaft and thereby being arranged to be driven in rotation about an axially extending centre axis.

### BACKGROUND OF THE INVENTION AND PRIOR ART

Known mixers comprises in general two or three blades, also known as vanes, which are connectable to a hug and which extends primarily in a radial direction in relation to said hub. Impeller assemblies comprises in its turn in general four or more blades.

DE 197,09,818 discloses a mixer for waste water, which mixer comprises three blades connectable to a hub. Each blade presents at its most inner portion in the radial direction an attachment plate. These attachment plates are connected to the hub of the mixer by means of screws/attachment means extending in the radial direction, which screws are screwed into the attachment plate from inside the hub. Thus, each blade is tightened radially inwards against the hub by means of said screws. It should be pointed out that said blades during operation of the mixer, which is arranged to be driven in rotation, experience considerable bending load in the rotational direction as well as torsional load about a radially extending axis extending across the attachment plate of the blade. Due to the radial mounting of the blade to the hub, both loads shall be carried by the screws by means of which the blades are fastened. Besides that, the mounting is time consuming and troublesome since the great number of screws per blade and since the accessibility for tightening the screws is extremely limited.

In other known embodiments each blade presents at its most inner portion in the radial direction a rod/pin, which is inserted in the radial direction into a seat of the hub. The object of said rod is, together with the hub, to carry a part of the above mentioned bending load in the rotational direction of the mixer. However, such a set of rod and seat must present a play free engagement with each other, which result in the disadvantage that they, due to the inhospitable and demanding environment in which the mixer is located, easily corrodes and thereby irrevocably becomes connected to each other. This entails that even if a single blade is broken the entire mixer assembly must nevertheless be exchanged.

### BRIEF DESCRIPTION OF THE OBJECT OF THE INVENTION

The present invention aims at obviating the aforementioned disadvantages and failings of previously known propeller assemblies, and at providing an improved propeller assembly. A primary object of the present invention is to provide an improved propeller assembly of the initially defined type, which admits simple and easily accessible mounting and attachment of each blade to the hub.

It is another object of the present invention to provide a propeller assembly where the bending and torsional loads on each blade is not carried by the attachment means by means of which the blades are secured to the hub.

It is yet another object of the present invention to provide a propeller assembly that admits a great number of mounting and demounting of the blades without auxiliary tools, without running the risk of mounting the blades incorrectly and thereby causing misbalance of the propeller assembly.

### BRIEF DESCRIPTION OF THE FEATURES OF THE INVENTION

According to the invention at least the primary object is attained by means of the initially defined propeller assembly, which is characterized in that the hub comprises a seat for each of said at least two blades, each seat comprising an axially extending first engagement means, and that each blade comprises an axially extending second engagement means, said first engagement means and said second engagement means concurrently being arranged to admit axial mutual displacement of said hub and each of said blades during mounting/demounting of the propeller assembly, and is thereto arranged to prevent radial mutual displacement of said hub and each of said blades when the mixer assembly is in an assembled condition.

Thus, the present invention is based on the understanding that axial mounting of each of the blades to the hub entail a simple and easily accessible mounting, and that the bending and torsional loads that the attachments of the blades to the hub are subject to are carried by engagement means instead of the attachment means by means of which each blade is secured to the hub.

Preferred embodiments of the present invention are further defined in the dependent claims.

Preferably each blade comprises an attachment means, which is disengageably connected to the hub and which is arranged to prevent axial mutual displacement of the hub and each of said blades in a mounted condition of the propeller assembly. This entail that the attachment means is used to attach the blade to the hub only and that the attachment means does not carry the torsional or bending loads, which result in a more safe attachment of the blades to the hub.

According to a preferred embodiment the hub comprises a rear hub base and a front hub top, said at least two blades being disengageably connectable to said hub base, and that said hub top is disengageably connectable to said hub base. Furthermore, it is more preferred that said first engagement means of each seat of the hub, and said second engagement means of each blade, are arranged radially inside the outer envelope surface of the hub. This division of the hub in a hub base and a hub top entails that the attachment of each blade in the hub base and the design of the first and the second engagement means, respectively, does not affect the fluid currents around the propeller assembly in a negative way, but are enclosed and protected by the hub top.

According to yet another preferred embodiment the second engagement means of each blade comprises at least two projections, which are mutually separated and which are arranged to engage at least two recesses of the cooperating first engagement means, each of said at least two projecttions of the second engagement means having the shape of a truncated cone tapering backwards in the axial direction. This results in that during mounting of the blade to the hub, they will automatically take the correct mutual position.

Further advantages and features of the invention are apparent from the other dependent claims as well as from the following detailed description of preferred embodiments.

### BRIEF DESCRIPTION OF THE DRAWINGS

A more complete understanding of the abovementioned and other features and advantages of the present invention will be apparent from the following detailed description of preferred embodiments in conjunction with the appended drawings, wherein:

FIG. 1 is an elevated view in the axial direction of an inventive mixer assembly,

FIG. 2 is a perspective view of a mixer assembly according to FIG. 1,

FIG. 3 is an exploded view in part taken from the side of a preferred embodiment of a mixer assembly,

FIG. 4 is an exploded perspective view of a mixer assembly,

FIG. 5 is a cross sectional side view of a mixer assembly,

FIG. 6 is a perspective view of the hub base and one blade according to a first embodiment,

FIG. 7 is a side view of a blade according to FIG. 6,

FIG. 8 is an elevated view in the axial direction of the blade according to FIGS. 6 and 7,

FIG. 9 is a perspective view of the hub base and one blade according to a second embodiment corresponding to FIG. 6,

FIG. 10 is a side view of the blade according to FIG. 9 corresponding to FIG. 7, and

FIG. 11 is a perspective view of a hub base.

### DETAILED DESCRIPTION OF PREFERRED EMBODIMENTS

By way of introduction it should be pointed out that the inventive propeller assembly include at least mixer assemblies of mixers and impeller assemblies of propeller pumps, however, the following detailed description will be directed towards a mixer assembly of a mixer, but it shall be realized that everything described below also apply to a impeller assembly of a propeller pump, unless otherwise stated.

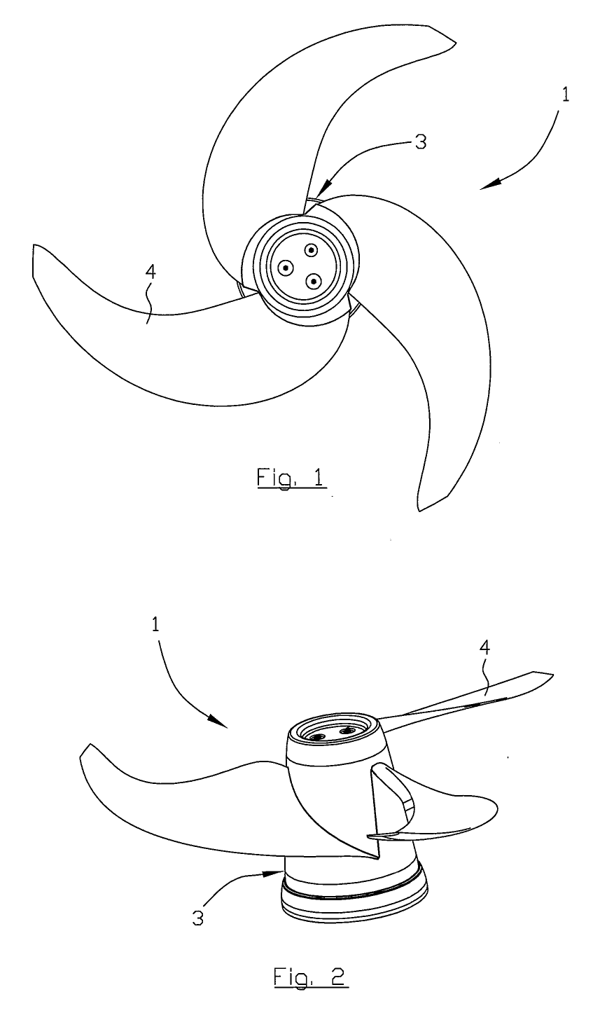

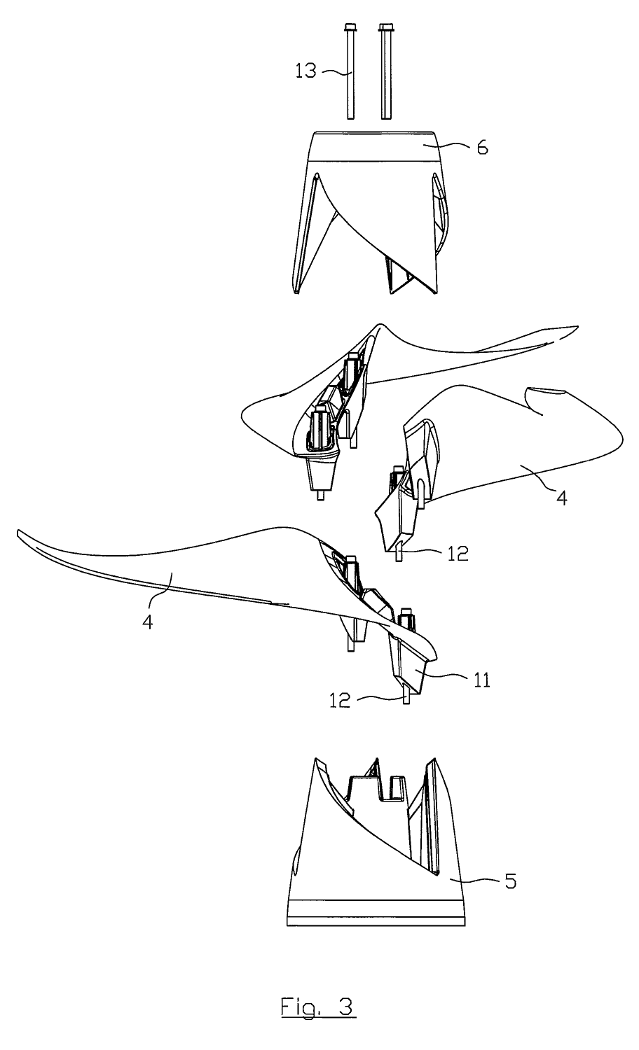

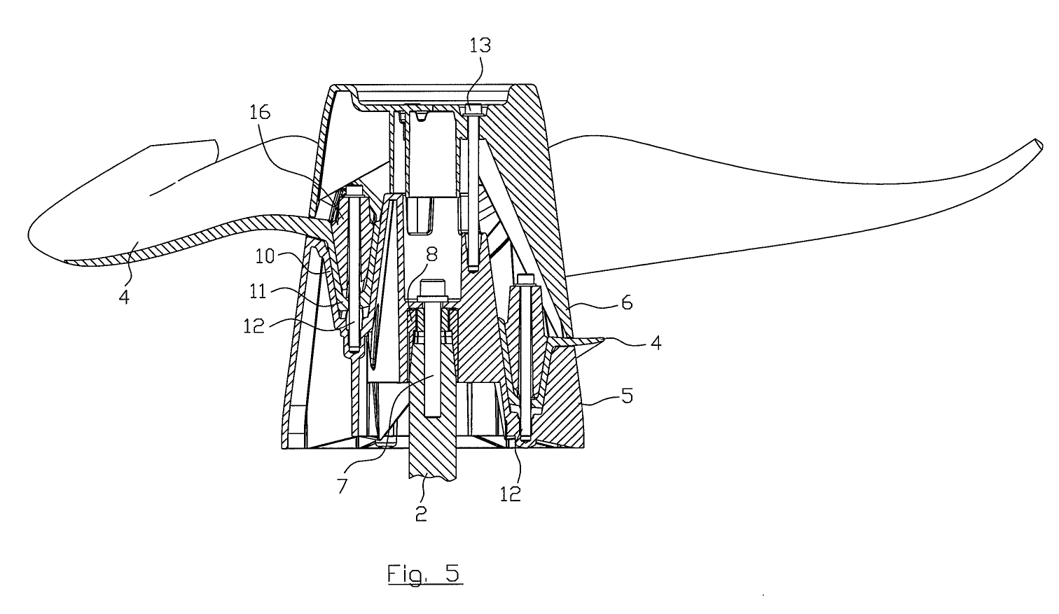

In FIGS. 1 and 2 is disclosed an inventive mixer assembly, generally designated 1, in a mounted condition. However, it should be pointed out that the mixer assembly 1 is part of a greater mixer (not shown), which besides the inventive mixer assembly 1 also comprises a motor unit having an output drive shaft 2, see FIG. 5. Mixer assemblies are suitable for agitating waste water or the like, i.e. generating and maintaining a movement within waste water. Mixer assemblies comprise a hub, generally designated 3, and at least two blades 4, preferably three blades. The blades 4 are releasably connected to the hub 3 and extend in general in radial direction in relation to the hub 3. In a conventional way the blades 4 presents a shape adapted for the task to agitate a fluid, which shape in occurring cases entail that each blade 4 presents double curved main surfaces on its suction side and pressure side, respectively. In a preferred embodiment each blade 4 receives its shape by molding, and is preferably manufactured by aluminum. The hub 3 in its turn presents a free front end and a rear end, the hub 3 in said rear end being arranged to be connected to said drive shaft 2 and thereby being arranged to be driven in rotation about an axially extending centre axis.

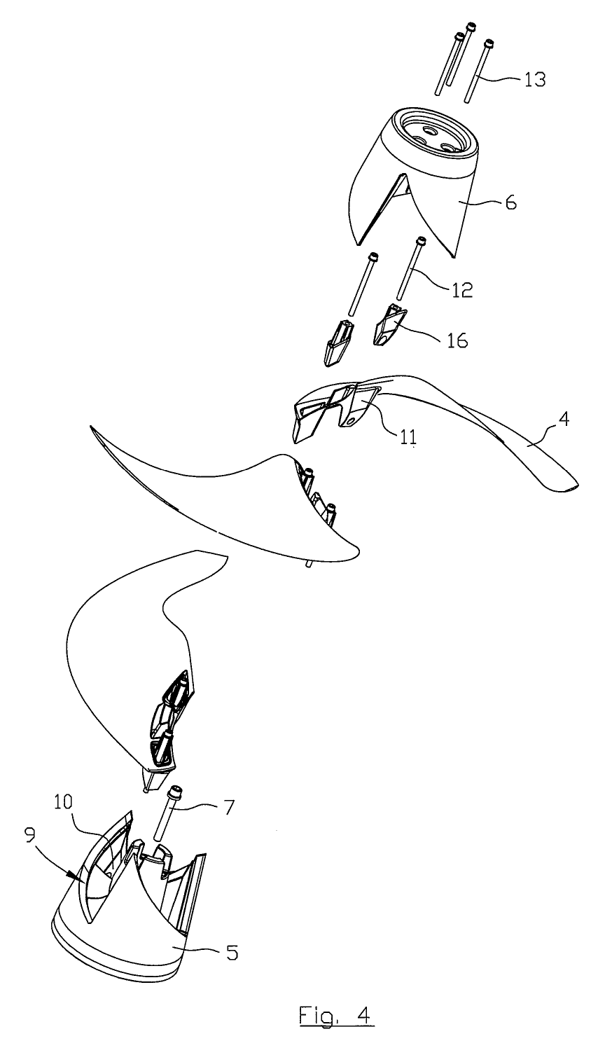

Reference is now made to FIGS. 3 and 4, which discloses the inventive mixer assembly 1 according to a first embodiment in an elevated exploded view and a perspective exploded view, respectively, as well as to FIG. 5 disclosing the inventive mixer assembly 1 according to FIGS. 3 and 4 in an elevated sectional view.

In the disclosed embodiment the hub 3 comprises a rear hub base 5 and a front hub top 6, the hub base 5 being arranged to be connected to said drive shaft 2. The hub base 5 presents in the disclosed embodiment a rearward opened hole for receiving the drive shaft 2, whereupon the hub base 5 is secured to the end of the drive shaft 2 be means of a screw 7 axially screwed into the drive shaft 2. Furthermore the fastening of the hub base 5 to the drive shaft 2 may be additionally strengthen be means of utilizing a tool cone 8, which is seated in the rearward opened hole and which clamp the end of the drive shaft 2 concurrently with the tightening of the screw 7. In the preferred embodiment the hub base 5 and the hub top 6, respectively, receives their shape by molding, and are preferably manufactured by aluminum.

According to the invention the hub 3 comprises a seat, generally designated 9, for each of said blades 4. Each seat 9 comprises in its turn a first engagement means 10 extending in the axial direction, and each blade 4 comprises a second engagement means 11 extending in the axial direction. Said first engagement means 10 and said second engagement means 11 are in cooperation arranged to admit axial mutual displacement of said hub 3 and said each blade 4 during mounting/demounting of the mixer assembly 1. Furthermore, the first engagement means 10 and the second engagement means 11 are arranged to prevent radial mutual displacement of the hub 3 and each blade 4 when the mixer assembly 1 is in the mounted condition. Thus, it is essential for the invention that the blades 4 are applied axially to the hub 3. It should be pointed out that the abutment between each blade 4 and the hub 3, when the mixer assembly 1 is in the mounted condition, only occur between the first engagement means 10 and the second engagement means 11, in order to prevent over determined positioning of the blades 4 and accompanying origin of internal strain.

Furthermore, the blades 4 of the mixer assembly, in the preferred embodiment, are releasably connected to the hub base 5 by means of axially extending screws 12, or other suitable fastening means. Each blade 4 comprises preferably at least one screw 12 that prevents axial mutual displacement/separation of the hub 3 and said each blade 4 when the mixer assembly is in the mounted condition. The axial application of the screws 12 entail easy and quick mounting/demounting of the blades 4 to the hub. Furthermore, the hub top 6 is releasably connected to the hub base 5 by means of axially extending screws 13, or other suitable fastening means. The axial application of the screws 13 entail easy and quick mounting/demounting of the hub top 6 to the hub base 5. The purpose of the hub top 6 is at first hand to provide good fluid current properties around the mixer assembly 1. Furthermore, it is an object of the hub top 6 to act as a protective device if the attachment means of a blade 4 breaks and the blade 4 thereby is released from the hub base 5. In the case when a blade 4 has come loose from the hub base 5 it will be noticed long before the blade 4 is thrown away and runs the risk of damaging other equipment of personnel, due to the fact that the hub top 6 tolerable keeps the blade 4 in place or at least prevents the blade 4 from flinging away.

In an alternative embodiment (not shown) the mixer assembly is arranged in such a way that the blades 4 are attached axially to the hub top 6, which thereafter is connected to the hub base 5. In yet another alternative embodiment (not shown) the blades 4 are attached axially to the hub base 5 from the rear direction, whereupon the hub base 5 is connected to the end of the drive shaft 2 in any suitable way. It shall be pointed out that in the latter embodiment no hub top is required. Independently on which parts being connected to which, it is preferred that said first engagement means 10 of each seat 9 of the hub 3, and said second engagement means 11 if each blade 4, are arranged radially inside the outer envelope surface of the hub 3 when the mixer assembly is in the mounted condition. In that way good fluid current properties are obtained and the engagement means and the attachment means are protected against the environment in which the mixer assembly is arranged to work.

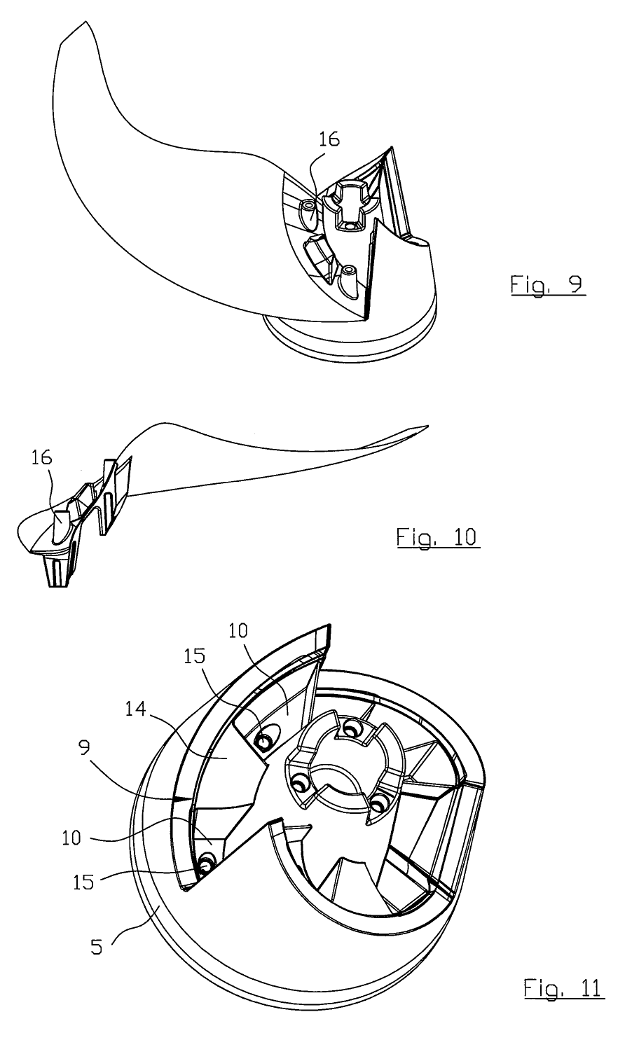

Now reference is made to FIG. 11. In the preferred embodiment said first engagement means 10 of each seat 9 comprises at least two recesses, which are mutually separated in the circumferential direction of the hub 3, and which are separated by means of an intermediate wall 14. Preferably said at least two recesses are mutually separated also in the axial direction of the hub 3. In mixer assemblies the front recess seen in the rotational direction of the propeller assembly is located closer to the rear end of the hub 3 then the rear recess seen in the rotational direction of the propeller assembly. However, it should be pointed out that in impeller assemblies there is the opposite relation, more precisely that the front recess seen in the rotational direction of the propeller assembly is located closer to the free end of the hub 3 then the rear recess seen in the rotational direction of the propeller assembly. Alternatively the first engagement means 10 is constituted by an elongated recess extending in the circumferential direction. Preferably each recess provides a threaded whole 15 in the bottom thereof for receiving above mentioned screw 12. Furthermore, the second engagement means 11 of each blade 4 comprises in the preferred embodiment at least two projections, which are mutually separated and which are arranged to engage said recesses of the first engagement means 10. By analogy with the description of the recesses above the mixer assembly is arranged in such a way that the front projection seen in the rotational direction of the propeller assembly is located closer to the rear end of the hub 3 then the rear projection seen in the rotational direction of the propeller assembly. Furthermore, it should be pointed out that in mixer assemblies there is the opposite relation, more precisely that the front projection seen in the rotational direction of the mixer assembly is located closer to the free end of the hub 3 then the rear projection seen in the rotational direction of the mixer assembly. In the case when the first engagement means 10 is constituted by one recess only, the second engagement means 11 is preferably constituted by one projection only.

It should be pointed out that the opposite relationship that the first engagement means 10 comprises projections and the second engagement means 11 comprises interacting recesses may apply without deviating from the invention.

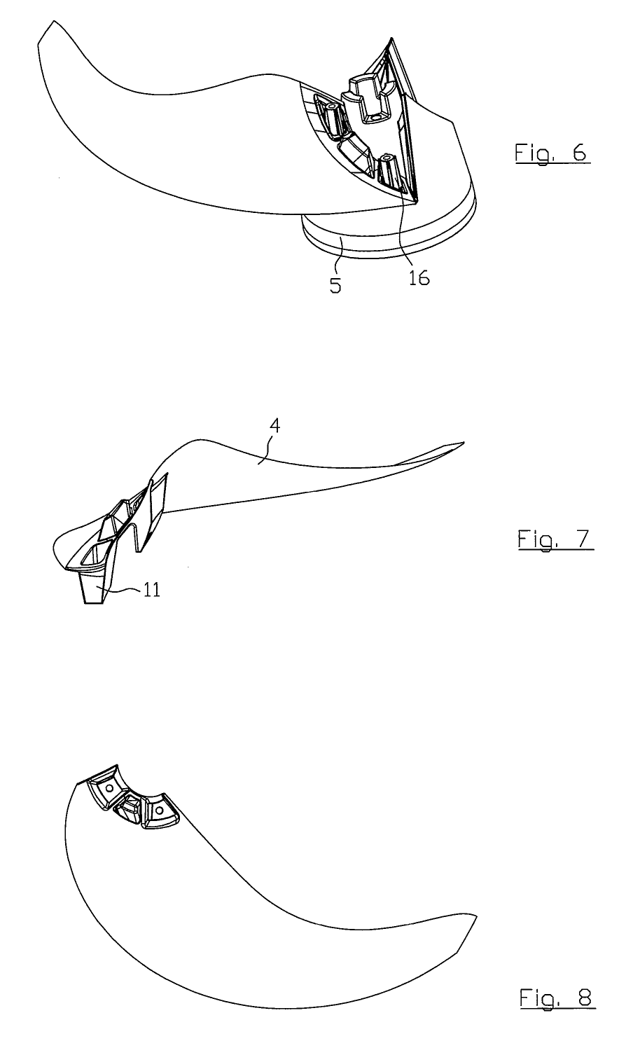

Reference is now specifically made to FIGS. 7 and 8. It is preferred that each of said at least two projections of the second engagement means 11 presents the shape of a truncated cone tapering rearward in the axial direction, and that each of said at least two recesses of the first engagement means 10 presents complementary shape. The inclination of outer surface of said at least two projections and the inner surface of said at least two recesses in relation to an axially extending centre line shall be as small as possible in order to admit as perpendicular force transmission as possible between the first engagement means 10 and the second engagement means 11. However, the angle must be big enough to admit easy axial application and removal of the blade 4 in relation to the hub 3. Preferably this angle shall be less than 45 degrees, preferably less than 20 degrees. In the shown preferred embodiment said angle is about 10 degrees. Furthermore, the angle shall be bigger than 5 degrees.

It is preferred that said projection of the second engagement means 11 is arranged to abut the front projection of the first engagement means 10 in the rotational direction as well as in the radial direction, and the rear projection of the second engagement means 11 is arranged to abut the rear recess 10 of the first engagement means 10 in the radial direction only. By this way a well defined positioning of each blade 4 is obtained at the same time as the risk of internal stress of the hub 3 and blade 4 will arise is minimized. Further, it is preferred that at the abutment interface there is surface abutment.

It is yet preferred that each of said at least two projections of the second engagement means 11 and that each of said at least two recesses of the first engagement means 10 presents a polygonal cross section, for instance square shaped. However, it should be pointed out that it is equally preferred that each of said at least two projections of the second engagement means 11 and each of said at least two recesses of the first engagement means 10 present a round cross section, for instance circular. The advantage of having a round cross section of the front projection and the front recess is that the engagement between them will not carry the bending loads acting on the blade 4 in the rotational direction, instead the bending load on the blade 4 will be carried in interaction with the engagement between the rear projection and the rear recess. Thereto it is preferred that each of said at least two projections of the second engagement means 11 presents a smaller axial extension than the axial extension of the corresponding recess of said at least two recesses of the first engagement means 10, see FIG. 5. In this way a correct positioning in the radial direction of the separate blade 4 in relation to the hub 3 is guaranteed, and the projections of the second engagement means 11 is not running the risk of touching the bottom of the recesses of the first engagement means 10.

In order to obtain appropriate screw engagements at the attachment of the blades 4 to the hub 5, according to the embodiments according to FIGS. 3-8 a separate distance sleeve 16 is used together with each projection of the second engagement means 11. The object of the distance sleeve 16 is to admit that long enough, and thereby resilient enough, screws 12 may be used. Due to the fact that the abutment interface between the first engagement means 10 and the second engagement means 11 is flat, as described above, relatively large settlement will take place when the first engagement means 10 and the second engagement means 11 have run in, and a long pretensioned screw can handle this without coming loose, but a short pretensioned screw should quickly come loose. The screws 12 will in principal be loaded in their longitudinal direction only, due to the fact that the first engagement means 10 and the second engagement means 11 are arranged to carry mutual loads in the radial direction and in the rotational direction between the blades 4 and the hub 5 of the mixer assembly. In FIGS. 9 and 10 there is shown a preferred embodiment in which the distance sleeves 16 are fixedly connected to or most preferably integrated with the second engagement means 11.

### FEASIBLE MODIFICATIONS OF THE INVENTION

The invention is not limited only to the embodiments described above and shown in the drawings, which primarily have an illustrative and exemplifying purpose. This patent application is intended to cover all adjustments and variants of the preferred embodiments described herein, thus the present invention is defined by the wording of the appended claims and the equivalents thereof. Thus, the mixer assembly may be modified in all kinds of ways within the scope of the appended claims.

It shall also be pointed out that all information about/concerning terms such as above, below, etc., shall be interpreted/read having the equipment oriented according to the figures, having the drawings oriented such that the references can be properly read. Thus, such terms only indicates mutual relations in the shown embodiments, which relations may be changed if the inventive equipment is provided with another structure/design.

It shall also be pointed out that even thus it is not explicitly stated that features from a specific embodiment may be combined with features from another embodiment, the combination shall be considered obvious, if the combination is possible.

1. Mixer assembly for generating and maintaining a movement within waste water, comprising a hub (3) and at least two blades (4), which are releasably connected to said hub (3) and which extends in the radial direction in relation to the hub (3), furthermore the hub (3) presents a free front end and a rear end, the hub (3) in said rear end being arranged to be connected to a drive shaft and thereby being arranged to be driven in rotation about an axially extending centre axis, wherein the hub (3) comprises a seat (9) for each of said at least two blades (4), each seat (9) comprising an axially extending first engagement means (10), and that each blade (4) comprises an axially extending second engagement means (11), said first engagement means (10) and said second engagement means (11) together being arranged to admit axial mutual displacement of said hub (3) and each of said blades (4) during mounting/demounting of the propeller assembly, and is thereto arranged to prevent radial mutual displacement of said hub (3) and each of said blades (4) when the mixer assembly is in an assembled condition.

2. Mixer assembly according to claim 1, wherein each blade (4) comprises at least one attachment means (12), which is releasably connected to the hub (3) and which is arranged to prevent axial mutual displacement of the hub (3) and sat each blade (4) when the mixer assembly is in an assembled condition.

3. Mixer assembly according to claim 1, wherein said hub (3) comprises a rear hub base (5) and a front hub top (6), said at least two blades (4) being releasably connected to said hub base (5), and in that said hub top (6) is releasably connected to said hub base (5).

4. Mixer assembly according to claim 1, wherein said first engagement means (10) of each seat (9), and said second engagement means (11) of each blade (4), are arranged radially inside the outer envelop surface of the hub (3).

5. Mixer assembly according to claim 1, wherein said first engagement means (10) of each seat (9) comprises at least two recesses, which are mutually separated in a circumferential direction of the hub (3).

6. Mixer assembly according to claim 5, wherein said second engagement means (11) of each blade (4) comprises at least two projections, which are mutually separated and which are arranged to engage said at least two recesses of the first engagement means (10).

7. Mixer assembly according to claim 6, wherein each of said at least two projections of the second engagement means (11) presents truncated cone shape tapering in the rearward axial direction.

8. Mixer assembly according to claim 6, wherein each of said at least two projections of the second engagement means (11) presents a polygonal cross section.

9. Mixer assembly according to claim 6, wherein each of said at least two projections of the second engagement means (11) presents a round cross section.

10. Mixer assembly according to claim 1, wherein each of said at least two projections of the second engagement means (11) presents a less axial extension than the axial extension of the corresponding recess of said at least two recesses of the first engagement means (10).

11. Mixer assembly according to claim 2, wherein said hub (3) comprises a rear hub base (5) and a front hub top (6), said at least two blades (4) being releasably connected to said hub base (5), and in that said hub top (6) is releasably connected to said hub base (5).
